(19) United States
(12) Patent Application Publication
(10) Pub. No.: US 2022/0079276 A1
(43) Pub. Date: Mar. 17, 2022

(54) Face Covering With Removable Filtering Element

(71) Applicant: LuxeAvant Innovations, Inc., West Vancouver (CA)

(72) Inventors: Arash Mohammadian-Khezerlou, Vancouver (CA); Arash Ross Seyed, Vancouver (CA); Behzad Ghods-Mahmoudzadeh, Vancouver (CA); Pedram Hosseini, Vancouver (CA)

(21) Appl. No.: 17/023,952

(22) Filed: Sep. 17, 2020

(51) Int. Cl. A41D 27/20; B01D 46/00; A41D 23/00

(52) U.S. Cl. CPC A41D 27/20; B01D 2279/40; A41D 23/00; B01D 46/0005

(57) ABSTRACT

A neck gaiter includes a body having a generally tubular or cylindrical shape. The gaiter includes a pair of closure mechanisms at each open end of the body in order to facilitate and securely retain the placement of the gaiter where desired on the wearer. The length of the material forming the gaiter enables the gaiter to be worn around the neck, over the nose and mouth of the wearer and over at least a portion of the head of the wearer, providing additional wearable position configurations for the gaiter. The gaiter includes a pocket formed thereon within which a filter element can be positioned. The pocket is located on the gaiter in a location where the pocket and filter element are readily positioned over the nose and mouth of the wearer.

### FIELD OF THE DISCLOSURE

The present invention relates generally to face coverings and in particular to a neck-gaiter having a pocket or insertion of air or respiratory filtering element.

### BACKGROUND OF THE DISCLOSURE

In many situations, individuals want or are required to cover their face and neck area for various reasons. These reasons can be aesthetic or can be health-related. In either situation, as it is more difficult to breathe through a covering of a person's nose and mouth, it is desirable that the face covering restrict the breathing of the individual wearing it as little as possible and/or that it be readily moveable between a covered configuration and a uncovered configuration.

While many types of face coverings take the form of masks that are positioned over the nose and mouth of the wearer, these mask do not satisfy the need for an aesthetic face covering that can be worn by the individual even when not covering the face.

To address this shortcoming of masks, various types of garments called neck gaiters have been developed. The neck gaiter is a generally tubular fabric garment that is readily positioned and collapsible around the neck of the wearer to be used as a scarf. The soft fabric forming the gaiter allows the gaiter to be comfortably worn around the neck of the individual below the face. When desired, the gaiter can be pulled upwardly over the nose and mouth of the individual into a covering position.

While the neck gaiter is able to aesthetically serve the purpose of providing a selectively deployable face covering, in many situations the fabric forming the gaiter is insufficient to provide suitable protection from particulate materials and/or gases in the air surrounding the wearer. To address those needs, a number of gaiters have been developed in which the gaiter includes a filter element in the gaiter structure. Examples of these types of garments are disclosed in Barklow US Patent Application Publication No. US2016/0213959; Kroese et al. US Patent Application Publication No. 2010/0039859; Baker U.S. Pat. No. 7,288,858; and Yarahmadi U.S. Pat. No. 9,661,884, each of which is expressly incorporated by reference herein in their entirety for all purposes.

While alone or in combination these prior art neck gaiters are capable of being moved between the uncovered position where the gaiter is disposed around the neck of the wearer and the covered position where the gaiter is placed over the moth and nose of the wearer, they have various shortcomings, such as concerning the manners in which the gaiters can be worn and in how they can locate a filter in over the nose and mouth of the wearer for additional protection to the wearer, among others.

In particular, as a result of their construction, the prior art gaiters are limited to being utilized in the positions around the neck of the wearer, the uncovered position, or covering the nose and mouth. of the wearer, the covered position.

Further, the placement of the filter over the nose and mouth of the wearer is exclusively controlled by the shape, size and location of the pocket holding the filter. Thus, the gaiter must be adjusted relative to the wearer to locate the filter over the nose and mouth when the filter moves within the pocket, such as due the movement of the individual wearing, the gaiter.

Thus, it is desirable to develop a gaiter that can. overcome the shortcomings of the prior art.

### SUMMARY OF THE DISCLOSURE

According to one aspect of an. exemplary embodiment of the invention., a neck gaiter includes a body having a generally tubular or cylindrical shape. The gaiter includes a pair of closure mechanisms at each open end of the body in order to facilitate and securely retain the placement of the gaiter where desired on the wearer. The length of the material forming the gaiter enables the gaiter to be worn around the neck, over the nose and mouth of the wearer and over at least a portion of the head of the wearer, providing additional wearable position configurations for the gaiter over the prior art.

According to another aspect of an exemplary embodiment of the invention, the gaiter includes a pocket formed thereon within which a filter element can be positioned. The pocket is located on the gaiter in a location where the pocket is readily positioned over the nose and mouth of the wearer. The closure mechanisms of the gaiter enable the wearer to properly and securely locate the gaiter on the wearer where the filter element is disposed directly over the nose and mouth of the wearer. This position of the filter can be maintained by the closure mechanisms even during movement of the wearer.

According to still another aspect of an exemplary embodiment of the invention, the pocket can include a number of mechanical fasteners to secure the pocket in a closed position. The fasteners can additionally be employed to secure the filter element within the pocket, further maintaining the position of the filter element in the desired location.

Other aspects, advantages and features of the invention of the present disclosure will be made apparent from the following detailed description taken together with the drawing figures.

### BRIEF DESCRIPTION OF' THE DRAWINGS

The drawings illustrate the best mode currently contemplated of practicing the present invention. Exemplary embodiments of the article of furniture are shown in the accompanying drawings, it should be appreciated that like reference numbers used in the drawings may identify like components.

FIGS. 1A-IF are isometric views of a gaiter constructed according to an exemplary embodiment of the present disclosure and worn in different configurations by a wearer.

FIG. 2 is a front isometric view of the gaiter of FIG. 1.

FIG. 3 is an. isometric view of a first embodiment of the gaiter of FIG. in an. inside-out configuration.

FIG. 4 is an isometric view of a second embodiment of the gaiter of FIG. 2 in an inside-out configuration.

FIG. 5 is an isometric view of a third embodiment of the gaiter of FIG. 2.

FIG. 6 is an isometric view of the gaiter of FIG. 5 in an inside-out configuration.

### DETAILED DESCRIPTION OF THE DRAWINGS

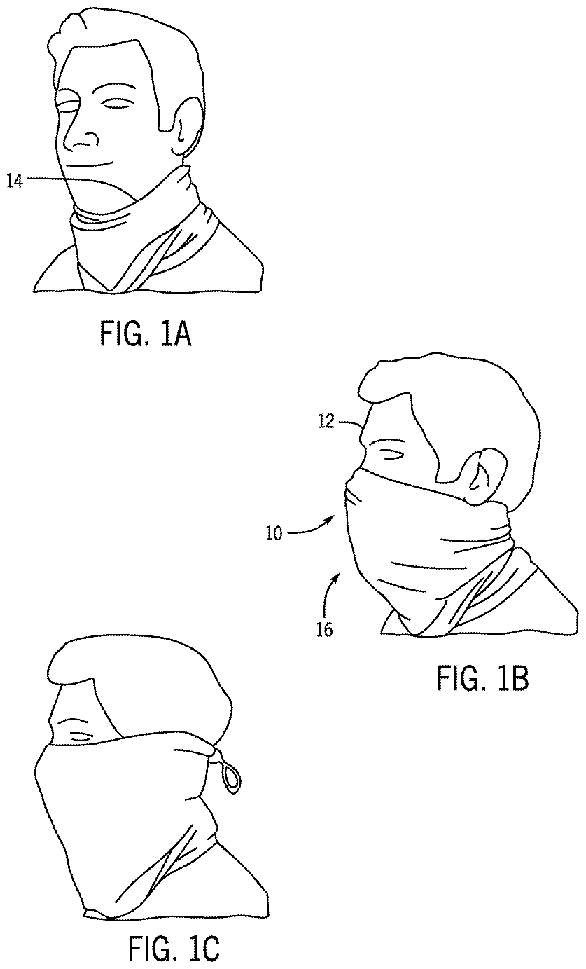

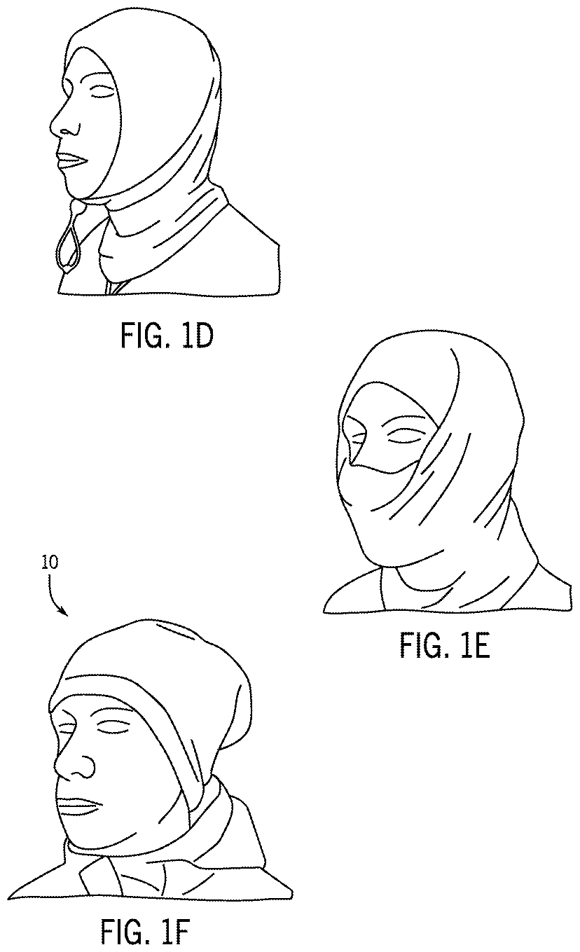

With reference now to the drawing figures in which like reference numerals designate like parts throughout the disclosure, an exemplary embodiment of a gaiter is illustrated generally at 10 in FIGS, 1A-1F, The gaiter 10 is a garment to be worn on the head 12 and/or neck 14 of a wearer 16 in various convertible configurations, such as a neck scarf (FIG. 1A), a face covering (FIG. 1B), a face and ear covering (FIG. 1C), a head and neck scarf (FIG. 1D), a head and neck scarf with face covering (FIG. 1E) and a head covering (FIG. 1F),

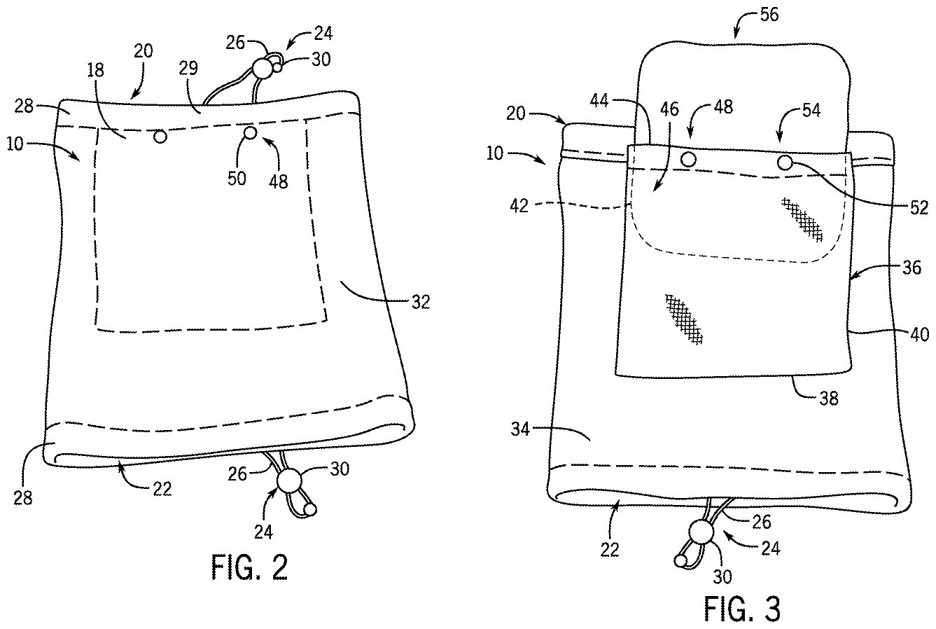

As best shown in FIG. 2, the gaiter 10 includes a body 18 formed of a suitable garment material, such as a single or multi-layer fabric material, that has a generally cylindrical or tubular shape with a pair of open ends 20, 22 disposed at opposed ends of the body 18. At least one and optionally both of the open ends 20, 22 include closure mechanisms 24 disposed thereon that are capable of closing the open ends 20, 22 against the portion of the head 12 and/or neck 14 of the wearer 16 that is desired to be covered by the gaiter 10. In the illustrated exemplary embodiment of FIG. 2, the closure mechanisms 24 take the form of drawstrings 26 inserted through channels 28 formed at each open end 20, 22, such as by folding the ends (not shown) of the material forming the body 18 at the open ends 20, 22 back on itself and securing the ends to the body 18, thus defining the channel 28 at the open ends 20, 22, each of which also include a pair of slits or openings 29 at each end to enable the drawstrings 26 to exit the channels 28. The drawstrings 26 are formed of any suitable material, such. as an elastic material, that is capable of being tightened or drawn into a configuration that snugly conforms to the shape of the body part of the wearer 16 against which the open ends 20, 22 are positioned. The drawstrings 26 also are each positioned within an adjustment mechanism 30 that enables the length of the drawstring 26 within the channels 28 to be adjusted, thereby adjusting the size of the open ends 20, 22. In one exemplary manner of operation, the drawstrings 26 can be pulled through the adjustment mechanism 30 to narrow the size of the open end 20, 22. When the drawstring 26 has narrowed the open end 20, 22 sufficiently, such as when the open end 20, 22 contacts and/or engages the head 12 or neck 14 of the wearer 16, the adjustment mechanism 30 can be engaged with the drawstring 26 to retain the drawstring 26, and the associated open end 20, 22, in that desired configuration. Conversely, when it is desired to reposition or remove the gaiter 10, the adjustment mechanism 30 can be disengaged from the drawstring 26 to enable the drawstring 26 to be moved to enlarge the size of the associated open end 20, 22.

The ability of the drawstring 26 to shape the open ends 20,22 as desired to conform to the shape of the body part against which the open end 20,22 of the body 18 of the gaiter 14 is engaged enables the gaiter 10 to be securely fastened to the wearer 16 in a wider variety of configurations than prior art gaiters 10. More particularly, the drawstrings 26 enable the open ends 20, 22 to be tightly secured to the head 12 and neck 14 of the wearer 16 in all of the configurations shown in FIGS. 1A-1F simply by drawing the body 18 of the gaiter 10 where desired and securing the drawstrings 26 against the body of the wearer 16 at the associated locations. It is a simple matter to adjust the position of the gaiter 10 by disengaging one or both drawstrings 26 and moving the body 18 of the gaiter 10 to the desired configuration. As a result, the location and flexible material forming the drawstrings 26 at the top and bottom open ends 20, 22 of the gaiter 10 allow for easy adjustment of the top and bottom open ends 20, 22 of the gaiter 14 such that the gaiter 10 can be used by both males and females with a wide range of head and neck shapes and sizes.

Further, the avoidance of flaps or other opposed portions of the gaiter 10 that need to be secured to one another, as in prior art gaiters, greatly increases the ease of engaging and adjusting the gaiter on the head 12 and neck 14 of the wearer 16. Also, in another exemplary alternate embodiment, even when the drawstrings 26 are not tightly engaged with the wearer 16, the drawstrings 26 prevent the gaiter 10 from coming off of the wearer 16 by maintaining the gaiter 10 in loose engagement with the wearer 16. This is due to the drawstrings 26 being selected to have lengths that are slightly less than that of the diameter of the head 14 of a wearer 16. In this manner, even when loosened, the drawstrings 26 prevent the gaiter 20 from inadvertently being removed from the head 12 of the wearer 16. However., the elastic nature of material. forming the drawstrings 26 enables the drawstrings 26 to be stretched to allow the gaiter 10 to be readily drawn over and removed from the head 12 of the wearer 16.

Referring now to FIG. 3, the body 18 of the gaiter 10 includes an exterior surface 32 (FIG. 2) and an interior surface 34. The interior surface 34 can be formed simply of the opposite side of the material forming the body 18 from the exterior surface 32, but can additionally be formed from a separate or partial layer or layers of material secured to the exterior surface 32, which can be formed of the same, similar or dissimilar materials, or combinations thereof, in order to provide the desired aesthetic appearance and functionality to the gaiter 10.

In the illustrated exemplary embodiment of FIG. 3, the interior surface 34 of the gaiter includes a pocket 36 formed thereon. The pocket 36 is located adjacent one open end 20 and is formed of a suitable material that can be readily secured to the material farming the interior surface 34 and that is gas permeable. While the pocket 36 can have any desired shape, such as a single layer of material or an enclosure formed of two layers of material separate from the interior surface, in the exemplary embodiment of FIG. 3 the pocket 36 has a generally rectangular shape, and is affixed to the interior surface 34 along a bottom edge 38 and a pair of side edges 40, 42. The top edge 44 is unsecured to the interior surface 34 to enable access to an interior 46 of the pocket 36, The top edge 44 includes a securing mechanism 48 that is selectively engageable with the interior surface 34 to close the top edge 44 against the interior surface 34. The securing mechanism 48 can have a number of suitable configurations, such as buttons, a hook and loop closure, or a zipper, among others, and in the illustrated exemplary embodiment is farmed of a number of female receptacles 50 that can be engaged with male snap projections 52 on the interior surface 34 to farm a snap securing mechanism 54.

When disengaged, the securing mechanism 48 allows access to the interior 46 of the pocket 36 to enable a filter element 56 to be placed therein. The filter element 56 is capable of filtering a number of different contaminants out of the air passing through the filter element 56, including small particulate matter such as dust, pollen and virus-containing droplets, among others. The filter element 56 can have any suitable configuration, such. as a monolithic filter element, a layered fitter element, or any other type of air filtration structure that can be used by itself or in combination with another structure, such as a container or pouch for the filter element 56. In an exemplary embodiment, the filter element 56 is formed of a flexible material that enables the fitter element 56 to conform to the shape of the gaiter 10. When worn in any configuration. Further, the filter element 56 conforms closely to the shape of the pocket 36, such that filter element 56 does not readily slide within the pocket 36 and remains on the proper location on the gaiter 10 to provide optimal filtration to the wearer 16.

The position of the pocket 36 is provided on the interior surface 34 such that when the gaiter 10 is worn in a configuration to cover the face of the wearer 16, the pocket 36 and any filter element 56 disposed therein is properly located over the nose and mouth of the wearer 16 to provide filtration to the air being breathed in by the wearer 16.

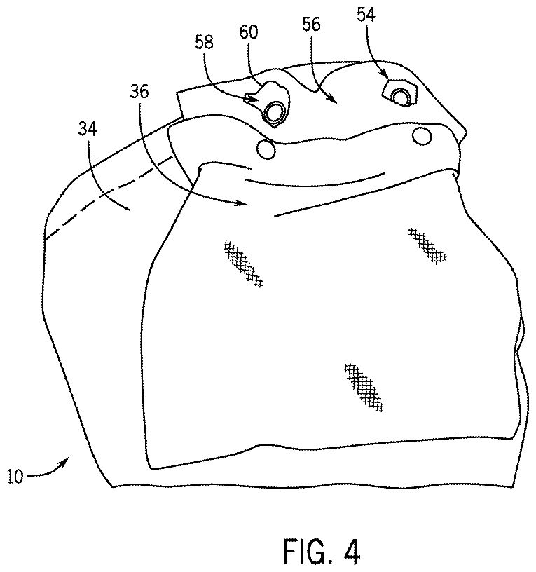

In an alternative embodiment, as shown in FIG. 4, to provide further enhancement to the stable positioning of the filter element 56 within the pocket 36, the filter element 56 can be formed with a securing structure 58 that is capable of engaging the securing mechanism 48 to hold the filter element 56 within the pocket 36. In the illustrated exemplary embodiment of FIG. 4, the securing structure 58 takes the form of opening 60 in the filter element 56 that can be aligned with the snap securing mechanism 54. In operation, upon insertion of the filter element 56 within the pocket 36, the openings 60 are positioned between the female receptacles 50 and the male snap projections 52. The receptacles 50 are subsequently engaged with the projections 52 through the openings 60, simultaneously closing the pocket 36 and holding the filter element 56 in position relative to the pocket 36 and the body 18 of the gaiter 10.

In an alternative exemplary embodiment, the pocket 36 can be formed to be releasably secured to the interior surface 34 of the gaiter 10. The pocket 36 can include one portion of a suitable engagement mechanism, such as zipper, hook and loop fastener closure, among others, that is engageable with the other portion disposed on the interior surface 34 of the gaiter 10. In this embodiment, the filter element 56 can be positioned within. the pocket 36, either with or without engagement of the filter element 56 with the securing structure 58, which can optionally be present on the pocket 36, and the pocket 36 is releasably secured to the interior surface 34 using the aligned portions of the engagement mechanism. The portion of the engagement mechanism on the interior surface 34 is located to position the filter element 56 directly in front of the nose and mouth of the wearer 16 when the gaiter 10 is placed on the head 12 of the wearer 16.

In still another exemplary embodiment, the pocket 36 can be omitted and the engagement mechanism can include a portion disposed on the interior surface 34 and on the filter element 56 that are releasably engageable with one another. In this manner, the filter element 56 can be directly secured to the interior surface 34 directly in front of the nose and mouth of the wearer 16 when the gaiter 10 is placed on the head 12 of the wearer 16.

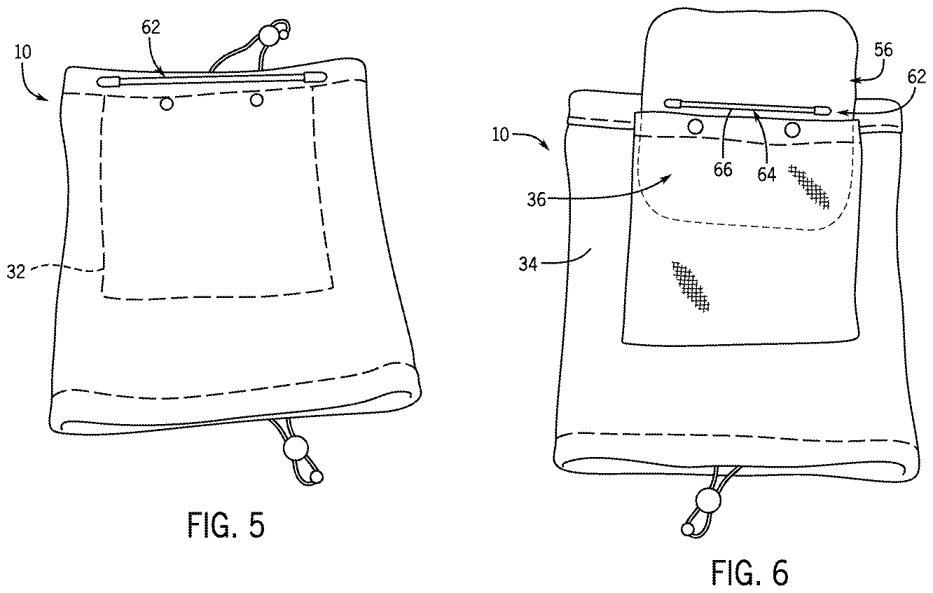

Looking now at the illustrated exemplary embodiments shown in FIGS. 5 and 6, any of the previous embodiments can include a slip resistant sealing strip 62 secured to the gaiter 10. The strip 62 is formed of a. slip resistant material, such as a silicone rubber, and can be affixed to any suitable surface of the gaiter 10, in the illustrated embodiment, the strip 62 is secured to the interior surface 34 adjacent the pocket 36, such that the strip 62 can contact the skin of the wearer 16 and conform to the shape of the portion of the skin of the wearer 16 contacted by the strip 62, thereby providing an anti-slip function for the gaiter 10 and/or sealing the strip 6 against the wearer 16 to provide significantly reduced and optionally no air flow between the strip 62 and the wearer 16. In addition, the strip 62 can include an integral or removable structural member 64, such as a wire 66 coated with the silicone rubber, that provides an amount of structural rigidity to the strip 62. Alternatively, the strip 62 can be formed exclusively of the wire 66 which is flexible in order to enable the strip 62 to be bent to conform to the shape of the wearer 16 while retaining the desired shape the wire 66 is formed or bent into, and maximize the anti-slip and sealing function of the strip 62 against the skin of the wearer 16. in still other exemplary embodiments, the strip 62 can be positioned out of direct contact with the wearer 16, such as on the exterior surface 32, or between layers of material (not shown) that define interior and exterior layers for the body 18 of the gaiter 10.

In other alternative, exemplary embodiments the gaiter 1 can include additional strips 62 in other locations on the gaiter 10, which can provide further adaptability to the gaiter 10.

In addition to the several. aspects and advantages of the present disclosure which have been described and illustrated, it should be noted that various additional aspects and advantages of the present invention may be envisioned by those persons who are skilled in the garment art and are intended to be encompassed within the scope of the following claims particularly pointing out and distinctly claiming and the subject matter regarded as the invention.

We claim:

1. A garment comprising:
a. a cylindrical body having a pair of opposed open. ends;
b. a closure mechanism disposed at and retained within the body adjacent each open end,

2. The garment of claim 1 wherein the closure mechanism comprises an elastic drawstring retained within a channel formed in the body at each. open end.

3. The garment of claim 2 wherein the drawstring is formed as loop.

4. The garment of claim 2 further comprising an adjustment mechanism engaged with the drawstring to enable a length of the drawstring within the channel to be adjusted to alter the size of the associated open end.

5. The garment of claim 1 wherein the body defines an exterior surface and an interior surface, and further comprising a pocket disposed on the interior surface of the body.

6. The garment of claim. 5 further comprising a closure mechanism engaged between the pocket and the interior surface of the body.

7. The gar merit of claim 6 further comprising a filter element disposed within the pocket.

8. The garment of claim 7 wherein the filter element includes a pair of openings engaged with the closure mechanism,

9. The garment of claim. 8 wherein the closure mechanism comprises:
a. a number of female receptacles on the pocket; and
b. a number of complementary male projections on the interior surface of the body, and w
herein the male projections are inserted through the openings into engagement with the female receptacles.

10. The garment of claim 5 further comprising at least one anti-slip sealing strip disposed on the interior surface of the body.

11. The garment of claim 10 wherein the anti-slip sealing strip comprises a flexible support member covered with an anti-slip coating material.

12. A method of selectively covering the nose and mouth of an individual for filtering air being breathed by the individual, the method comprising the steps of:
a. providing a garment a cylindrical body defining an interior surface and an exterior surface and having a pair of opposed open ends, an elastic drawstring closure mechanism disposed at and retained within the body adjacent at least one open end and a pocket disposed on the interior surface of the body;
b. positioning a filter element within the pocket; and
c. placing the garment over the head of the individual; and
d. securing the closure mechanism to engage the drawstring with portions of the head of the individual to position the filter element over the nose and mouth of the wearer.

13. The method of claim 12 further comprising the steps of;
a. releasing the closure mechanism to adjust the position of the garment on the head of the individual; and
b. re-securing the closure mechanism to the head of the individual.

14. The method of claim 12 wherein the step of securing the closure mechanism simultaneously positions the filter element over the nose and mouth of the wearer and the garment over the head of the wearer.
